(19) United States
(12) Patent Application Publication
(10) Pub. No.: US 2007/0221229 A1
(43) Pub. Date: Sep. 27, 2007

(54) Endotracheal tube apparatus and method for use

(75) Inventors: Franck Rahaghi, Weston, FL (US); Juan Botero, Weston, FL (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: The Cleveland Clinic Foundation

(21) Appl. No.: 11/586,443

(22) Filed: Oct. 25, 2006

Related U.S. Application Data
(60) Provisional application No. 60/731,790, filed on Oct. 31, 2005.

(51) Int. Cl. A62B 9/06

(52) U.S. Cl. 128/207.14; 604/27

(57) ABSTRACT

A convertible endotracheal tube apparatus includes an outer lumen member, an inner lumen member, an outer lumen cuff, and an inner lumen cuff. The outer lumen member has a round tubular cross-section and is adapted to provide a first fluid path between a first external fluid source and both a left and a right lung of a patient. The inner lumen member has a semi-round tubular cross-section, is located at least partially within the round tubular cross-section of the outer lumen member, and is adapted to selectively provide a second fluid path between a second external fluid source and a chosen one of the left and right lungs. The outer lumen cuff encircles a portion of the outer lumen member and selectively provides a single lumen operation mode. The inner lumen cuff encircles a portion of the inner lumen member and selectively provides a double lumen operation mode.

### RELATED APPLICATION

This application claims priority from U.S. provisional patent application Ser. No. 60/731,790, filed Oct. 31, 2005, the subject matter of which is incorporated herein by reference.

### TECHNICAL FIELD

The present invention relates to an endotracheal tube apparatus and method for use and, more particularly, to an endotracheal tube apparatus which is convertible between a single lumen operation mode and a double lumen operation mode to selectively independently ventilate a patient's left and right lungs.

### BACKGROUND OF THE INVENTION

Thoracic surgery often requires that both the left and right lungs of a patient be ventilated separately, to allow the anesthesiologist to deflate one lung and continue to ventilate the other during the operation. The double lumen endotracheal tubes currently used for this separate ventilation must be removed and exchanged for a single lumen tube at the end of the surgery if ventilation to both lungs is required by the patient during recovery.

The double-to-single lumen tube exchange generally occurs because double lumen arrangements suitable for surgery are cumbersome for post-operative care, particularly if the patient is ill and requires intensive care. For example, a single lumen tube, which is simple to connect with various ventilation machines during post-operative care, is easier for a busy nursing staff to deal with than a double lumen tube because the staff does not have to determine which of several possible connection couplings on a double lumen tube is the correct attachment point for the ventilation machine.

However, the double-to-single lumen tube exchange has several distinct disadvantages. Most significantly, any intubation of the patient's lungs requires instrumental contact with the delicate structures of the mouth, nose, oropharynx, and throat and brings about the risks of mechanical damage and infection to the teeth or sinuses, trachea, lung structures, and the like. Further, the patient's trachea may swell or become markedly irritated or inflamed during surgery, such that the extraction of the double lumen tube and subsequent insertion of the single lumen tube may cause unnecessary tearing or friction damage to the swollen trachea, beyond the ordinary risk of tearing or friction damage posed by a basic intubation. Additionally, the exchange requires the expense of providing two separate endotracheal tube apparatuses. Finally, the exchange adds complexity and time to what may already be a difficult and long surgery, thus increasing the amount of time that the patient must be anesthetized and also requiring extra concentration effort from the surgical team. Therefore, it is most desirable to provide an endotracheal tube which can be converted between single and double lumen operation modes without requiring a re-intubation of the patient for recovery in the post-anesthesia care unit or the intensive care unit.

An example of a convertible endotracheal tube apparatus is disclosed in U.S. Pat. No. 5,660,175, issued Aug. 26, 1997 to Bimal Dayal (hereafter referenced as the '175 patent). The '175 patent discloses an endotracheal tube comprising a common slave unit and an endobronchial unit, used to provide single lung ventilation for surgical and non-surgical cases (Col. 1, lines 5-10). The common slave unit is first placed in the patient's trachea. After the common slave unit is placed in the patient's trachea, the tracheal cuff, also known as the first inflatable cuff, is inflated. Once the tracheal cuff is inflated, a seal is effected between the outside of the common slave unit and the trachea. The patient may then be ventilated. Either a left endobronchial tube or a right endobronchial tube is positioned in the patient. Once the left endobronchial tube or the right endobronchial tube is placed in the patient, one or more of the endobronchial cuffs is inflated to seal the respective bronchus. Once the endobronchial tube is positioned and sealed, the inner cuff is inflated to prohibit movement and/or dislodgment of the endobronchial tube with respect to the common slave unit and with respect to the bronchus. (Col. 8, lines 27-49.) Though the '175 patent is silent on the conversion of the endotracheal tube from double to single lumen use, it is presumed that the above procedure is simply reversed to provide this exchange.

The '175 patent makes no provision for securing the endobronchial tube from motion within the common slave unit. Therefore, the endobronchial tube of the '175 patent may rotate or slip during positioning or use and cause unnecessary and unintended contact with the patient's tracheal or bronchial structures. In addition, the '175 patent uses up to four inflatable cuffs to secure the various elements of the endotracheal tube from relative motion, whereas current nonconvertible endotracheal tubes use only two cuffs, so additional training will be required for the user of the '175 patent device. Similarly, once the endobronchial tube of the '175 patent is removed and the common slave unit functions as a single lumen device, the remaining connection/attachment structure is unchanged. In a single-lumen operation mode, the connection coupling area of the '175 patent device still resembles that of a double lumen device and users may require additional training to properly connect a ventilation machine to the '175 patent device, thereby increasing the risk of erroneous post-operative use of the '175 patent device.

Accordingly, the art has sought a method and apparatus of a convertible endotracheal tube apparatus which: minimizes injury and damage to the patient, requires little to no additional user training, may be used in a timely and efficient manner, and is more economical to manufacture and use.

The present invention is directed to an apparatus overcoming one or more of the problems as set forth above.

### SUMMARY OF THE INVENTION

In an exemplary embodiment of the present invention, a convertible endotracheal tube apparatus is disclosed. The convertible endotracheal tube apparatus includes an outer lumen member, an inner lumen member, an outer lumen cuff, and an inner lumen cuff. The outer lumen member has a round tubular cross-section and is adapted to provide a first fluid path between a first external fluid source and both of a left and a right lung of a patient. The inner lumen member has a semi-round tubular cross-section, is located at least partially within the round tubular cross-section of the outer lumen member, and is adapted to selectively provide a second fluid path between a second external fluid source and a chosen one of the left and right lungs. The outer lumen cuff encircles a portion of the outer lumen member and is adapted to selectively provide a single lumen operation mode. The inner lumen cuff encircles a portion of the inner lumen member and is adapted to selectively provide a double lumen operation mode. The inner lumen member is selectively removable from within the outer lumen member to convert between the single and double lumen operation modes.

In an exemplary embodiment of the present invention, a method of selectively independently ventilating a left lung and a right lung of a patient is disclosed. The method includes the steps of providing an endotracheal tube apparatus including an outer lumen member having a round tubular cross-section, inserting the outer lumen member into an oropharynx of the patient and guiding the outer lumen member into a trachea of the patient, and actuating an outer lumen cuff of the endotracheal tube apparatus to form a first fluid path between a first external fluid source and the left and right lungs. The method also includes the steps of providing an inner lumen member of the endotracheal tube apparatus having a semi-round tubular cross-section, inserting the inner lumen member into the outer lumen member, longitudinally extending a distal end of the inner lumen member past a distal end of the outer lumen member, guiding the distal end of the inner lumen member into a chosen one of a left or right lung of the patient, and actuating an inner lumen cuff of the endotracheal tube apparatus to form a second fluid path between a second external fluid source and the chosen lung and to isolate the chosen lung from the first fluid path.

In an exemplary embodiment of the present invention, an apparatus for selectively independently ventilating a left lung and a right lung of a patient is disclosed. The apparatus includes an outer lumen member, an inner lumen member, an outer lumen cuff, an outer cuff channel, an inner lumen cuff, and an inner cuff channel. The outer lumen member has a proximal end removably attachable to a first external fluid source and a distal end spaced apart from the proximal end. The outer lumen member is also adapted to provide a first fluid path between the first external fluid source and both of the left and right lungs of the patient. The inner lumen member has a proximal end removably attachable to a second external fluid source and a distal end spaced apart from the proximal end. The inner lumen member is also selectively located within the outer lumen member and is adapted to selectively provide a second fluid path between the second external fluid source and a chosen one of the left and right lungs of the patient. The outer lumen cuff is attached to the outer lumen member adjacent the distal end of the outer lumen member. The outer cuff channel is located within a wall of the outer lumen member and provides fluid communication between the outer lumen cuff and an outer cuff fluid source. The inner lumen cuff is attached to the inner lumen member adjacent the distal end of the inner lumen member. The inner cuff channel is located within a wall of the inner lumen member and provides fluid communication between the inner lumen cuff and an inner cuff fluid source. The outer lumen cuff is selectively actuated to provide a single lumen operation mode and the inner lumen cuff is selectively actuated to provide a double lumen operation mode.

### BRIEF DESCRIPTION OF THE DRAWINGS

For a better understanding of the invention, reference may be made to the accompanying drawings, in which:

FIG. 1 is a front schematic view of an exemplary embodiment of the present invention;

FIG. 2a is a cutaway side view of an exemplary embodiment of the present invention in one mode;

FIG. 2b is a cutaway side view of an exemplary embodiment of the present invention in another mode;

FIG. 3 is a cross-sectional plan view taken along line 3-3 of FIG. 2a;

FIG. 4a is a side view of a double lumen adapter of an exemplary embodiment of the present invention; and

FIG. 4b is a side view of a single lumen adapter of an exemplary embodiment of the present invention.

### DESCRIPTION OF EMBODIMENTS

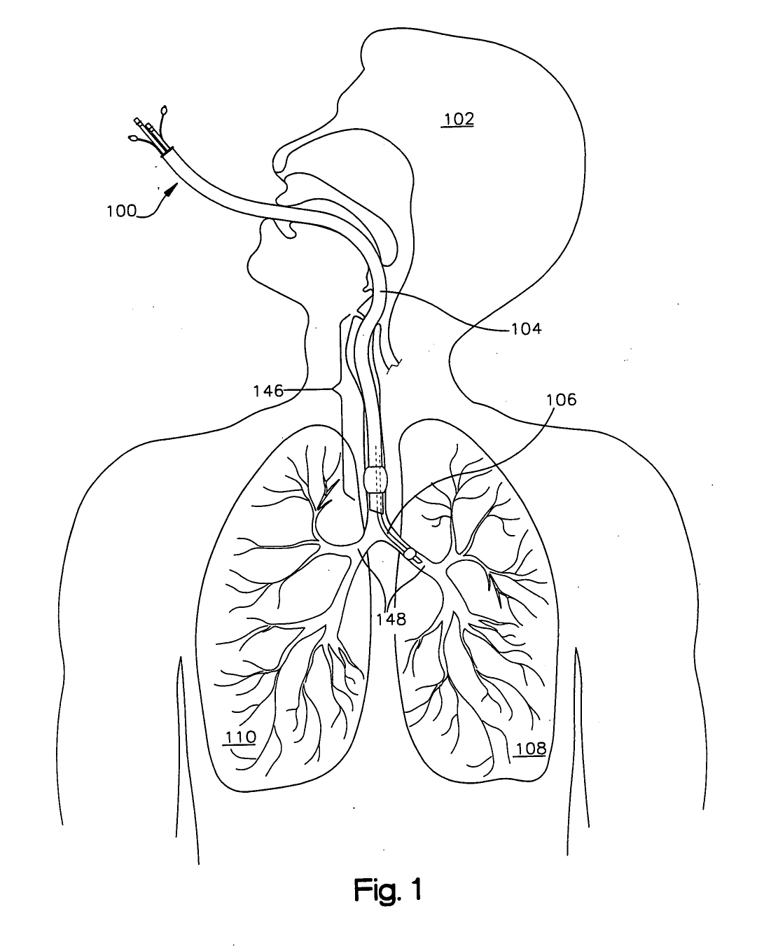

In accordance with the present invention, FIG. 1 depicts a schematic view of an exemplary embodiment of a convertible endotracheal tube apparatus 100 in place within the body of a human patient 102. The convertible endotracheal tube apparatus 100 includes an outer lumen member 104 and an inner lumen member 106. The outer lumen member 104 is adapted to provide a first fluid path between a first external fluid source (not shown) and both a left lung 108 and a right lung 110 of the patient 102. The inner lumen member 106 is adapted to provide a second fluid path between a second external fluid source (not shown) and a chosen one of the left and right lungs 108 and 110. The inner lumen member 106 may selectively be inserted into, and removed from, the outer lumen member 104 to provide the convertible function of the convertible endotracheal tube apparatus, as will be explained in more detail below.

The first and second external fluid sources may differ depending upon the treatment being provided to the patient 102. Contemplated fluid sources include such connections as breathing air, medical oxygen, anesthetic mixtures, vacuum devices to remove mucus or other substances from the patient 102, the normal atmosphere outside the patient 102, and the like. The first and second external fluid sources may be embodied in a single external device or may be changed from one type to another as the treatment of the patient 102 progresses. The exact natures of the first and second external fluid sources are not essential to the present invention and may be readily determined for any desired application of the present invention by one of ordinary skill in the art.

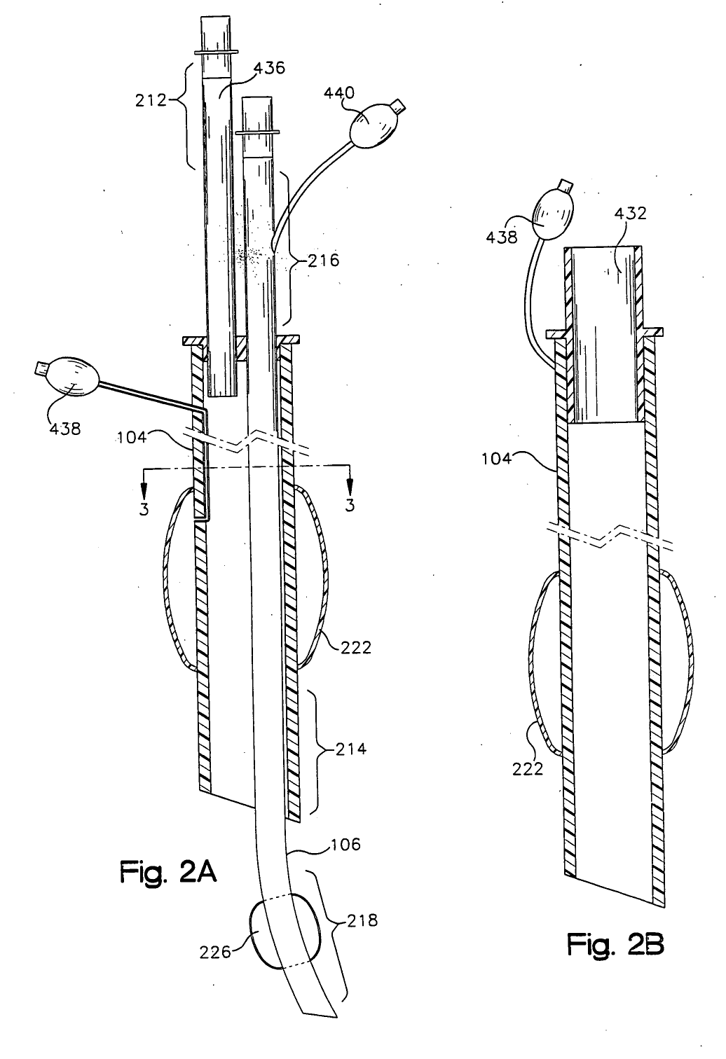

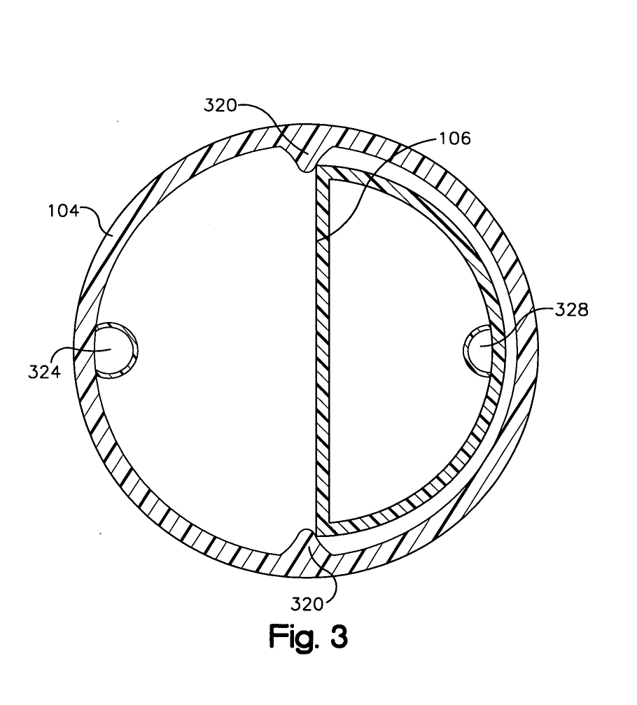

The outer lumen member 104 includes a proximal end 212 removably attachable to the first external fluid source and a distal end 214 spaced apart from the proximal end 212, as shown in FIG. 2a. The outer lumen member 104 has a round tubular cross-section, as shown in FIG. 3; that is, a cross-section of the outer lumen member 104 is of a substantially circular configuration, having a single wall completely surrounding a relatively large and generally circle-shaped central void.

The round tubular cross-section of the outer lumen member 104 is utilized because such a circular configuration minimizes protrusions and differing widths (as with an oblong or other non-circular configuration) around the circumference of the outer lumen member 104 and therefore reduces the opportunities for the outer lumen member 104 to contact or rub, and thereby damage, the internal tissues of the patient 102 during insertion or use. Also, a round tubular cross-section is symmetrical in all directions and therefore the user need not exercise special care to ensure that the outer lumen member 104 enters the patient 102 in a particular cross-sectional orientation or remains in that orientation during use. Finally, a circular circumference provides an efficient load-distributing shape that may resist inward bending or even total cross-sectional collapse of the outer lumen member 104 due to outside forces pressing on the outer lumen member 104. This resistance will help ensure a substantially constant flow rate through the first fluid path, which can be an important consideration for some types of thoracic treatments.

Depending upon the application, the outer lumen member 104 may have a cross-sectional area substantially equivalent to that of either a traditional nonconvertible double lumen endotracheal tube or a standard single lumen endotracheal tube. The dimensions of the components of the convertible endotracheal tube apparatus 100 are not essential to the present invention and may be readily determined by one of ordinary skill in the art for suitability to a desired application of the convertible endotracheal tube apparatus 100. For example, a range of lengths or diameters of outer lumen members 104 may be available for use with patients of different sizes and ages, or for different types of surgeries.

The inner lumen member 106 includes a proximal end 216 removably attachable to the second external fluid source and a distal end 218 spaced apart from the proximal end 216. As best shown in FIG. 2a, the distal end of the inner lumen member may have a beveled aspect to assist, in a known manner, in guiding the inner lumen member 106 as desired with a minimum of unnecessary contact with the tissues of the patient 102.

The inner lumen member 106 has a semi-round tubular cross-section; that is, a circumference of the inner lumen member 106 has a first portion with a substantially circular configuration, with the remaining portion of the circumference enclosing the cross-section of the inner lumen member 106 being either a straight line or another line/curve representing a substantial departure from the curvature of the first portion, as shown best in FIG. 3. Optionally, the curve of the first portion of the circumference of the inner lumen member 106 is chosen to be substantially similar to the curvature of the round cross-section of the outer lumen member 104.

A semi-round tubular cross-section for the inner lumen member 106 is utilized because such a configuration allows the inner lumen member 106 to fit or “nest” into one side of the outer lumen member 104 when the inner lumen member 106 is inserted into the outer lumen member 104. This nested arrangement serves to guide and support the inner lumen member 106 during use, as well as to reinforce the resistance to outside pressure of the outer lumen member 106.

In addition, the nested arrangement allows the first fluid path to have the largest possible continuous cross-sectional area when the inner lumen member 106 is located within the outer lumen member 104. A large cross-sectional area is desirable to avoid blockages when, for instance, the first fluid path is used to remove solid or semi-solid matter from at least one of the left and right lungs 108 and 110. The nested arrangement allows easier clog-free passage of large masses or solids than would, for instance, the donut-shaped void between inner and outer tubes in a known concentric tube-in-tube arrangement.

Optionally, the convertible endotracheal tube apparatus 100 includes at least one longitudinal guide member 320, as shown best in FIG. 3, which is disposed within the outer lumen member 104 and adapted to substantially restrain the inner lumen member 106 from at least one of lateral and rotational motions with respect to the outer lumen member 104. This restraint is performed by holding a portion of an outer surface of the inner lumen member 106 in contact with a portion of an inner surface of the outer lumen member 104, which provides obvious advantages in enlarging the continuous cross-sectional area of the first fluid path as previously discussed.

For example, the exemplary longitudinal guide member 320 shown in FIG. 3 takes the form of two opposed broken or solid ribs molded into the inner wall of the outer lumen member 104. The longitudinal guide member 320 may be formed into, or attached to, either or both of the outer and inner lumen members 104 and 106 without departing from the spirit and scope of the present invention. The longitudinal guide member 320 might optionally be confined to one or both of the areas adjacent the proximal ends 212 and 214 and the distal ends 216 and 218 of the outer and inner lumen members 104 and 106, respectively, while leaving the central lengths of the outer and inner lumen members 104 and 106 free from a longitudinal guide member 320. The nature and arrangement of the longitudinal guide member 320 may be readily determined by one of ordinary skill in the art for use in a particular application of the convertible endotracheal tube apparatus 100 and this choice is optionally at least partially based upon the chosen semi-round tubular cross-section of the inner lumen member 106.

An outer lumen cuff 222 encircles a portion of the outer lumen member 104 and is adapted to selectively provide a single lumen operation mode, as discussed below. Preferably, the outer lumen cuff 222 is located near the distal end 214 of the outer lumen member 104, in order to more rigidly stabilize the outer lumen member 104 from unwanted motion. The outer lumen cuff 222 is may be a known inflatable cuff, which comprises a balloon-like member sealed from fluid communication with the outer lumen member 104.

An outer cuff channel 324 is in fluid communication with the outer lumen cuff 222 and directs inflation fluid (not shown) from outside the patient 102 into the outer lumen cuff 222 in a known manner. For example, a squeeze bulb may be used to inflate the outer lumen cuff 222. Optionally, the outer cuff channel 324 is in the outer lumen member 104, possibly formed within the wall of the outer lumen member 104.

Likewise, an inner lumen cuff 226 encircles a portion of the inner lumen member 106 and is adapted to selectively provide the double lumen operation mode discussed below. The inner lumen cuff 226 is preferably located near the distal end 218 of the inner lumen member 106, for stabilization and sealing reasons. The inner lumen cuff 226 may be a known inflatable cuff.

An inner cuff channel 328 is in fluid communication with the inner lumen cuff 226 and directs inflation fluid (not shown) from outside the patient 102 into the inner lumen cuff 226 in a known manner. For example, a squeeze bulb may be used to inflate the inner lumen cuff 226. Optionally, the inner cuff channel 328 is in the inner lumen member 106, possibly formed within the wall of the inner lumen member 106.

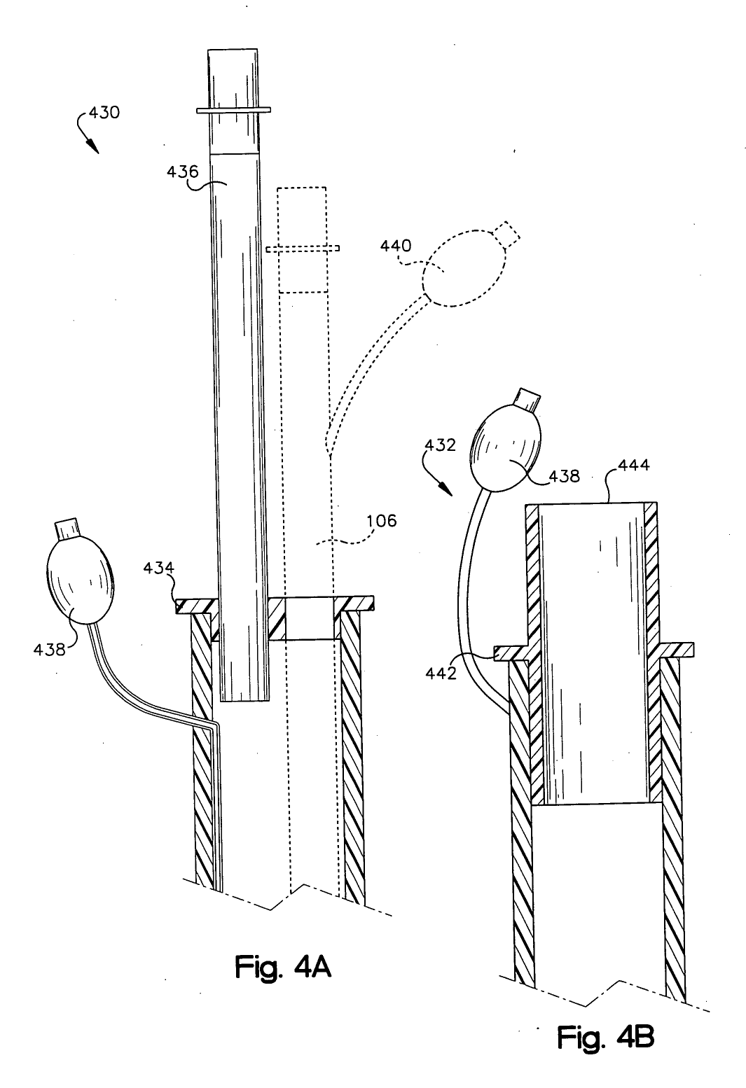

A double lumen adapter 430 and a single lumen adapter 432, as shown generally in FIGS. 2a and 2b, respectively, and in close-up in FIGS. 4a and 4b, respectively, are optionally used to convert the convertible endotracheal tube apparatus 100 between double and single lumen operation modes. When the adapters 430 and 432 are used, the proximal end 212 of the outer lumen member 104 is of a configuration, such as a simple blunt-ended tube, that is adapted to alternately accept both of the double and single lumen adapters 430 and 432. As shown in FIG. 4a, the double lumen adapter 430 includes a double cap member 434 and a double mode tube 436 which allows fluid communication along the first fluid path through the outer lumen member 104. The double cap member 434 engages the proximal end 212 of the outer lumen member 104.

The double lumen adapter 430 also preferably includes an outer cuff coupling 438, which is associated with the outer cuff channel 324 for fluid communication with the outer lumen cuff 222. The outer cuff coupling 438 may be of any suitable configuration. For example, the outer cuff coupling 438 may be an extension of the outer cuff channel 324, which protrudes from the proximal end 212 of the outer lumen member 104 and extends through an opening in the double lumen adapter 430 for inflation and deflation of the outer lumen cuff 222.

The double lumen adapter 430 includes an opening (not shown) to allow the inner lumen member 106 (shown in phantom in FIG. 4a) to be removably inserted into the outer lumen member 104. An inner cuff coupling 440 (shown in phantom in FIG. 4a) is associated with the inner cuff channel 328 for fluid communication with the inner lumen cuff 226. Akin to the relationship between the outer cuff coupling 438 and the outer cuff channel 324, the inner cuff coupling 440 may be an extension of the inner cuff channel 328 or any other configuration which allows desired control of the inner lumen cuff 226.

The single lumen adapter 432 is designed for use with the outer lumen member 104 in place of the double lumen adapter 430 when a single lumen operation mode, discussed below, is desired. The single lumen adapter 432 allows the convertible endotracheal tube apparatus 100 to be operable by a user in the same manner as a standard nonconvertible single lumen endotracheal tube, thus avoiding user confusion and possible patient discomfort during post-surgical care. The single lumen adapter 432 includes a single cap member 442, which engages the proximal end 212 of the outer lumen tube 104, and a single mode tube 444, which allows fluid communication along the first fluid path through the outer lumen member 104.

During thoracic surgery, a surgeon may wish to selectively ventilate a chosen one of the left and right lungs 108 and 110 of the patient 102 while preserving the capacity to collectively ventilate both of the left and right lungs 108 and 110 during recovery of the patient 102 after the surgery or at another desired time. The convertible endotracheal tube apparatus 100 is adapted to perform both of these functions.

To use the convertible endotracheal tube apparatus 100, an anesthesiologist or other physician intubates the patient 102 by guiding the outer lumen member 104 through the patient's nose or mouth, through the patient's oropharynx in a known manner, and into the patient's trachea 146. When the outer lumen member 104 is in position within the trachea 146 to provide a first fluid path into both of the left and right lungs 108 and 110, the outer lumen cuff 222 is activated, preferably by way of inflation provided through the outer cuff channel 324. For example, the outer lumen cuff 222 may inflate sufficiently to substantially fill a cross-sectional space between the outer lumen member 104 and the trachea 146. Once activated, the outer lumen cuff 222 acts in a known manner to hold the outer lumen member 104 in position within the trachea 146 while simultaneously sealing off the trachea to fluidly restrict the left and right lungs 108 and 110 to the first fluid path for fluid communication with the first external fluid source. This fluid restriction of the left and right lungs 108 and 110 to the first fluid path is the single lumen operation mode and may be desirable during or after surgery.

To provide the double lumen operation mode, which may be desirable during surgery, the outer lumen member 104 is initially placed as in the single lumen operation mode above, preferably with the outer lumen cuff 222 inflated to provide increased stability, then the distal end 218 of the inner lumen member 106 is inserted through the double lumen adapter 430 at the proximal end 212 of the outer lumen member 104 and guided through the length of the outer lumen member 104. Insertion of the inner lumen member 106 into the outer lumen member 104 optionally includes engaging some portion of one of the inner and outer lumen members 106 and 104 with at least one longitudinal guide member 320 on the other of the inner and outer lumen members 106 and 104, as discussed above with respect to the structures of the inner lumen member 106 and the longitudinal guide member 320.

The distal end 218 of the inner lumen member 106 is then extended out from the distal end 214 of the outer lumen member 104 so that the distal end 218 of the inner lumen member 106 becomes spaced further from the proximal end 212 of the outer lumen member 104 than the distal end 214 of the outer lumen member 104 is spaced from the proximal end 212 of the outer lumen member 104. Once the inner lumen member 106 is inserted through the outer lumen member 104, the distal end 218 of the inner lumen member 106 is guided into a bronchus 148 of a chosen one of the left and right lungs 108 and 110.

When the inner lumen member 106 is in a desired position within the bronchus 148 to provide a second fluid path into the chosen one of the left and right lungs 108 and 110, the inner lumen cuff 226 is activated, preferably by way of inflation provided through the inner cuff channel 328. Once inflated, the inner lumen cuff 226 acts in a known manner to hold the outer lumen member 104 in position within the bronchus 148 while simultaneously sealing off the chosen one of the left and right lungs 108 and 110 to fluidly restrict that chosen lung 108 and 110 to the second fluid path for fluid communication with the second external fluid source. For example, the inner lumen cuff 226 may inflate sufficiently to substantially fill a cross-sectional space between the inner lumen member 106 and the bronchus 148 or another portion of the chosen lung 108 and 110. The positioning of the inner lumen member 106 and inner lumen cuff 226 within the bronchus 148 of the chosen lung 108 and 110 also serves to fluidly isolate the chosen lung 108 and 110 from the first fluid path. This double lumen operation mode allows the left and right lungs 108 and 110 to be substantially fluidly isolated from each other while both still in fluid communication with one of the first and second external fluid sources.

Once the surgery is completed or it is otherwise desirable for the patient 102 to have both lungs in fluid communication with only the first fluid path (i.e., to be in the single lumen operation mode), the inner lumen cuff 226 is deflated or otherwise deactivated and the inner lumen member 106 is then optionally withdrawn from the outer lumen member 104 to place the convertible endotracheal tube apparatus 100 back into single lumen operation mode. Preferably, the double lumen adapter 430 is exchanged for a single lumen adapter 432 before or after the withdrawal of the inner lumen member 106, so that a nursing staff or other user providing further care to the patient 102 sees an interface with the convertible endotracheal tube apparatus 100 which appears substantially the same as that for a typical nonconvertible single lumen endotracheal tube. This resemblance allows the user to operate the convertible endotracheal tube apparatus 100 in substantially the same manner as the user operates the nonconvertible single lumen endotracheal tube, thus permitting use of the convertible endotracheal tube apparatus 100 during surgery without requiring the post-operative user to learn to recognize and operate another, possibly uncommon type of specialized equipment, as in the prior art.

Using proper sterilization procedures, it is contemplated that the convertible endotracheal tube apparatus 100 can be used alternately in the above-described single and double lumen operation modes multiple times with the same patient, thus avoiding the discomfort and possible trauma of repeatedly intubating the patient many times in close succession.

The method and apparatus of certain embodiments of the present invention, when compared with other apparatus and methods, may have the advantages of: minimizing injury and damage to the patient, requiring little to no additional user training, being usable in a timely and efficient manner, and being more economical to manufacture and use. Such advantages are particularly worthy of incorporating into the design, manufacture, and operation of endotracheal tubes. In addition, the present invention may provide other advantages which have not yet been discovered.

While aspects of the present invention have been particularly shown and described with reference to the exemplary embodiment above, it will be understood by those of ordinary skill in the art that various additional embodiments may be contemplated without departing from the spirit and scope of the present invention. For example, the longitudinal guide member 320 may take the form of a tongue-and-groove arrangement formed by the outer and inner lumen members 104 and 106. Further, the outer and inner cuff channels 324 and 328 may be formed contiguously with the outer and inner cuff couplings 438 and 440, respectively. Also, the inner lumen member 106 could be removed from, and inserted through, the outer lumen member 104 several times without removal of the outer lumen member 104 from the patient. In addition, the inner lumen member 106 can remain in place within the patient 102 with the inner lumen cuff 226 deactivated in the single lumen operation mode. Finally, it is contemplated that the patient 102 could be intubated with a convertible endotracheal tube apparatus 100 having an inner lumen member 106 already contained within the outer lumen member 104. However, a device or method incorporating such an embodiment should be understood to fall under the scope of the present invention as determined based upon the claims below and any equivalents thereof.

Other aspects, objects, and advantages of the present invention can be obtained from a study of the drawings, the disclosure, and the appended claims.

Having described the invention, the following is claimed:

1. A convertible endotracheal tube apparatus, comprising:
an outer lumen member having a round tubular cross-section, and adapted to provide a first fluid path between a first external fluid source and both of a left and a right lung of a patient;
an inner lumen member having a semi-round tubular cross-section, located at least partially within the round tubular cross-section of the outer lumen member, and adapted to selectively provide a second fluid path between a second external fluid source and a chosen one of the left and right lungs;
an outer lumen cuff encircling a portion of the outer lumen member and adapted to selectively provide a single lumen operation mode;
an inner lumen cuff encircling a portion of the inner lumen member and adapted to selectively provide a double lumen operation mode; and
wherein the inner lumen member is selectively removable from within the outer lumen member to convert between the single and double lumen operation modes.

2. The convertible endotracheal tube apparatus of claim 1, wherein the single lumen operation mode includes fluidly restricting the left and right lungs to the first fluid path and the double lumen operation mode includes selectively fluidly restricting the chosen one of the left and right lungs to the second fluid path while selectively fluidly isolating the chosen one of the left and right lungs from the first fluid path.

3. The convertible endotracheal tube apparatus of claim 1, wherein:
the outer lumen member has a proximal end removably attachable to a first external fluid source and a distal end spaced apart from the proximal end;
the inner lumen member has a proximal end removably attachable to a second external fluid source and a distal end spaced apart from the proximal end;
the distal end of the inner lumen member is selectively spaced further from the proximal end of the outer lumen member than the distal end of the outer lumen member is spaced from the proximal end of the outer lumen member; and
the inner lumen member is selectively insertable into and removable from the proximal end of the outer lumen member.

4. The convertible endotracheal tube apparatus of claim 1, including at least one longitudinal guide member disposed within the outer lumen member and adapted to hold a portion of an outer surface of the inner lumen member in contact with a portion of an inner surface of the outer lumen member and thereby substantially restrain the inner lumen member from at least one of lateral and rotational motions in relation to the outer lumen member.

5. The convertible endotracheal tube apparatus of claim 1, wherein the outer lumen member includes an outer cuff channel in fluid communication with the outer lumen cuff for directing inflation fluid to the outer lumen cuff, and the inner lumen member includes an inner cuff channel in fluid communication with the inner lumen cuff for directing inflation fluid to the inner lumen cuff.

6. The convertible endotracheal tube apparatus of claim 1, wherein a single lumen adapter is attached to the proximal end of the outer lumen member to provide the single lumen operation mode.

7. A method of selectively independently ventilating a left lung and a right lung of a patient, the method comprising the steps of:
providing an endotracheal tube apparatus including an outer lumen member having a round tubular cross-section;
inserting the outer lumen member into an oropharynx of the patient and guiding the outer lumen member into a trachea of the patient;
actuating an outer lumen cuff of the endotracheal tube apparatus to form a first fluid path between a first external fluid source and the left and right lungs;
providing an inner lumen member of the endotracheal tube apparatus having a semi-round tubular cross-section;
inserting the inner lumen member into the outer lumen member;
longitudinally extending a distal end of the inner lumen member past a distal end of the outer lumen member;
guiding the distal end of the inner lumen member into a chosen one of a left or right lung of the patient; and
actuating an inner lumen cuff of the endotracheal tube apparatus to form a second fluid path between a second external fluid source and the chosen lung and to isolate the chosen lung from the first fluid path.

8. The method of claim 7, including the step of removing the inner lumen member from the outer lumen member, wherein the chosen lung is placed into fluid communication with the first fluid path.

9. The method of claim 7, wherein the step of inserting the inner lumen member into the outer lumen member includes the steps of:
holding a portion of an outer surface of the inner lumen member into contact with an inner surface of the outer lumen member; and
restraining the inner lumen member from at least one of lateral and rotational motions in relation to the outer lumen member.

10. The method of claim 7, wherein the step of actuating an outer lumen cuff to form a first fluid path between a first external fluid source and the left and right lungs includes the steps of:
providing an outer cuff channel in the outer lumen member to allow fluid communication between an outer cuff and an outer cuff fluid source; and
expanding the outer cuff to substantially fill a cross-sectional space between the outer lumen member and the trachea.

11. The method of claim 10, wherein the step of actuating an inner lumen cuff to form a second fluid path between a second external fluid source and the chosen lung includes the steps of:
providing an inner cuff channel in the inner lumen member to allow fluid communication between an inner cuff and an inner cuff fluid source; and
expanding the inner cuff to substantially fill a cross-sectional space between the inner lumen member and at least a portion of the chosen lung.

12. The method of claim 7, further including providing a single lumen adapter on the outer lumen member, wherein the single lumen adapter allows a user to operate the endotracheal tube apparatus in substantially the same manner as the user operates a conventional nonconvertible single lumen endotracheal tube.

13. An apparatus for selectively independently ventilating a left lung and a right lung of a patient, the apparatus comprising:
an outer lumen member having a proximal end removably attachable to a first external fluid source and a distal end spaced apart from the proximal end, the outer lumen member being adapted to provide a first fluid path between the first external fluid source and both of the left and right lungs of the patient;
an inner lumen member having a proximal end removably attachable to a second external fluid source and a distal end spaced apart from the proximal end, the inner lumen member being selectively located within the outer lumen member and adapted to selectively provide a second fluid path between the second external fluid source and a chosen one of the left and right lungs of the patient;
an outer lumen cuff attached to the outer lumen member adjacent the distal end of the outer lumen member;
an outer cuff channel located within a wall of the outer lumen member and providing fluid communication between the outer lumen cuff and an outer cuff fluid source;
an inner lumen cuff attached to the inner lumen member adjacent the distal end of the inner lumen member; and
an inner cuff channel located within a wall of the inner lumen member and providing fluid communication between the inner lumen cuff and an inner cuff fluid source;
wherein the outer lumen cuff is selectively actuated to provide a single lumen operation mode and the inner lumen cuff is selectively actuated to provide a double lumen operation mode.

14. The apparatus of claim 13, wherein the single lumen operation mode includes fluidly restricting the left and right lungs to the first fluid path and the double lumen operation mode includes selectively fluidly restricting the chosen one of the left and right lungs to the second fluid path while selectively fluidly isolating the chosen one of the left and right lungs from the first fluid path.

15. The apparatus of claim 13, wherein the outer lumen member has a round tubular cross-section and the inner lumen member has a semi-round tubular cross-section.

16. The apparatus of claim 13, including at least one longitudinal guide member disposed within the outer lumen member and wherein, when the inner lumen member is located within the outer lumen member, the at least one longitudinal guide member substantially restrains the inner lumen member from at least one of rotational and lateral motions in relation to the outer lumen member.

17. The apparatus of claim 13, wherein a single lumen adapter is attached to the proximal end of the outer lumen member to provide the single lumen operation mode.
